(19) United States
(12) Patent Application Publication
(10) Pub. No.: US 2019/0345354 A1
(43) Pub. Date: Nov. 14, 2019

(54) Ultra-high whiteness aqueous white color paste for digital textile printing ink and an ink composition using the same

(71) Applicant: Everlight Chemical Industrial Corporation, Taipei City (TW)

(72) Inventors: Ya-Huang HUANG, Taoyuan City (TW); Chien-Ming CHEN, Taoyuan City (TW); Hsiao-San CHEN, Taoyuan City (TW)

(21) Appl. No.: 16/387,588

(22) Filed: Apr. 18, 2019

(30) Foreign Application Priority Data
May 8, 2018 (TW) 107115631

(51) Int. Cl. C09D 11/107; C09D 11/03; C09D 11/037

(52) U.S. Cl. CPC C09D 11/107; C09D 11/037; C09D 11/03

(57) ABSTRACT

An ultra-high whiteness aqueous white color paste for digital textile printing ink is provided, which comprises: 40 wt % to 70 wt % of TiO₂ powders; 1 wt % to 5 wt % of a wetting agent; 2 wt % to 12 wt % of a dispersant; and rest of water. Herein, the TiO₂ powders are rutile TiO₂ powders, the wetting agent is a fatty acid derivative, and the dispersant is an acrylic acid copolymer. In addition, the present disclosure thrther provides an ink composition using the aforesaid ultra-high whiteness aqueous white color paste.

### CROSS REFERENCE TO RELATED APPLICATION

This application claims the benefits of the Taiwan Patent Application Serial Number 107115631, filed on May 8, 2018, the subject matter of which is incorporated herein by reference.

### BACKGROUND

### 1. Field

The present disclosure relates to an aqueous white color paste for digital textile printing ink and an ink composition using the same. More specifically, the present disclosure relates to an ultra-high whiteness aqueous white color paste for digital textile printing ink and an ink composition using the same.

### 2. Description of Related Art

Even though the white color paste for digital textile printing ink is commercially available, the commercially available white color paste has the disadvantages of insufficient whiteness and unfavorable particle sizes. For example, the commercially available white color paste such as the products of DIC, Dainichiseika Color or Diamond has the problems of insufficient whiteness and large particle sizes, and cannot meet the user's requirement.

In the current white color paste, a small molecule solvent is used as a wetting agent. However, the test results indicate that the small molecule solvent cannot effectively improve the dispersion of the powders in the aqueous white color paste. For example, WO2012040889 discloses the use of the small molecule solvents such as diethylene glycol monobutyl ether (DEGMBE) and triethylene glycol monobutyl ether (TEGMBE). However, the test results indicate that the disclosed small molecule solvents cannot effectively improve the dispersion of the TiO₂ powders in the white color paste.

Therefore, it is desirable to provide an aqueous white color paste with ultra-high whiteness, stable dispersion and suitable particle size distribution to meet the requirement of the application thereof on the ink composition for digital textile printing.

### SUMMARY

An object of the present disclosure is to provide an ultra-high whiteness aqueous white color paste for digital textile printing ink, which has good stability and ultra-high whiteness.

The ultra-high whiteness aqueous white color paste for digital textile printing ink of the present disclosure comprises: 40 wt % to 70 wt % of TiO₂ powders; 1 wt % to 5 wt % of a wetting agent; 2 wt % to 12 wt % of a dispersant; and rest of water. Herein, the TiO₂ powders are rutile TiO₂ powders, the wetting agent is a fatty acid derivative, and the dispersant is an acrylic acid copolymer.

In the ultra-high whiteness aqueous white color paste of the present disclosure, the wettability of the TiO₂ powders (i.e. pigments) in an aqueous carrier can be unproved by using the fatty acid derivative as the wetting agent. Meanwhile, when the suitable dispersant is used, the dispersion of the TiO₂ powders (i.e. pigments) can be improved, and the proportion of the powders with large particle sizes can be effectively reduced. Thus, the obtained ultra-high whiteness aqueous white color paste can have good stability and superior whiteness. In addition, the ultra-high whiteness aqueous white color paste of the present disclosure has good pigment dispersion, so the particle size of the TiO₂ powders can be maintained in a certain range. Thus, when the ultra-high whiteness aqueous white color paste of the present disclosure is used to formulate an ink composition for digital textile printing, the TiO₂ powders does not block the nozzle for digital textile printing, and the printed ink can well fix on the textile (such as a cotton textile, a nylon textile, a non-woven textile, a linen textile or a textile made of other fibers) after a fixing process. Thus, the problem that the whiteness is not high enough can be prevented.

In the ultra-high whiteness aqueous white color paste of the present disclosure, the dispersant can be an anionic dispersant, a non-ionic dispersant or a combination thereof. The molecular weight of the dispersant can be ranged from 4000 to 10000. Preferably, the dispersant is the anionic dispersant. When the dispersant is the anionic dispersant, the dispersion of the TiO₂ powders can be improved. In one embodiment of the present disclosure, the acrylic acid copolymer as the dispersant can be a block acrylic acid copolymer, a random acrylic acid copolymer or a combination thereof. Preferably, the acrylic acid copolymer is a random acrylic acid copolymer. Examples of the dispersant suitable for the ultra-high whiteness aqueous white color paste of the present disclosure may include, but are not limited to Joncryl® HPD 196, Joncryl® 586, DISPERBYK-2015 or EDAPLAN® 480. Herein, the dispersant mentioned above can be used alone or two or more dispersants mentioned above can be used in combination.

In the ultra-high whiteness aqueous white color paste of the present disclosure, a molecular weight of the fatty acid derivative as the wetting agent can be ranged from 500 to 2000. Examples of the wetting agent suitable for the ultra-high whiteness aqueous white color paste of the present disclosure may include, but are not limited to TECO® Dispers652, EDAPLAN®915 or METOLAT 390. Herein, the wetting agent mentioned above can be used alone or two or more wetting agents mentioned above can be used in combination.

In the ultra-high whiteness aqueous white color paste of the present disclosure, a content of the wetting agent can be ranged from 1 wt % to 5 wt %, and preferably ranged from 1.5 wt % to 3 wt %.

In the ultra-high whiteness aqueous white color paste of the present disclosure, Dv50 of the TiO₂ powders is ranged from 200 nm to 320 nm, and Dv95 of the TiO₂ powders is less than 500 nm. Preferably, Dv50 of the TiO₂ powders is ranged from 200 nm to 300 nm, and Dv95 of the TiO₂ powders is less than 500 nm. In the present disclosure, the Dv50 (or Dv0.5) is the particle size of the median for a volume distribution; and the Dv95 is the particle size below which 95% of the volume of particles exists.

In addition, a CIE whiteness of the ultra-high whiteness aqueous white color paste of the present disclosure is greater than 85.

Furthermore, the ultra-high whiteness aqueous white color paste of the present disclosure is prepared by pulverizing a mixture containing primary TiO₂ powders, the wetting agent, the dispersant and the water through a milling process. Herein, the milling process can be a media milling process, a basket milling process, a high speed dispersion process, or a combination thereof, and the milling process mentioned above can be used alone or two or more milling processes mentioned above can be used in combination. There are no constraints on the milling media. In addition, Dv50 of the primary TiO₂ powders used for preparing the ultra-high whiteness aqueous white color paste is greater than 320 nm, and Dv95 thereof is greater than 500 nm. Furthermore, the primary TiO₂ powders is commercial available rutile TiO₂ powders after surface treatment with aluminum or organic materials.

The ultra-high whiteness aqueous white color paste of the present disclosure is mainly used for digital textile printing. Thus, the present disclosure further provides an ink composition for digital textile printing, which comprises: 15 wt % to 20 wt % of the aforesaid ultra-high whiteness aqueous white color paste; 20 wt % to 35 wt % of a resin; 1 wt % to 3 wt % of a cross-linking agent; 0.1 wt % to 0.5 wt % of a surfactant; 15 wt % to 30 wt % of a water soluble organic solvent; 0.1 wt % to 0.2 wt % of a biocide; and rest of water.

Other objects, advantages, and novel features of the invention will become more apparent from the following detailed description when taken in conjunction with the accompanying drawings.

### DETAILED DESCRIPTIO OF THE EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Unless specified otherwise, singular words “a” and “the” used in the present specification and claims include one or plural objects.

Unless specified otherwise, term “or” used in the present specification and claims include meaning of and/or.

In the following embodiments (Ex) and comparative embodiments (Comp. Ex) of the present disclosure, the mixture containing primary TiO₂ powders, a wetting agent, a dispersant and water according to the formulation shown in the following Table 1 was pulverized by a media milling process, a basket milling process or a high speed dispersion process for 2 hours to disperse the TiO₂ powders. After the milling process, aqueous white color pastes of the embodiments and the comparative embodiments were obtained.

Measurement of particle sizes

A particle size analyzer, Malvern Mastersizer 2000, was used to detect the particle sizes.

Herein, the symbol (⊚) refers to that Dv50 is ranged from 250 nm to 290 nm, and Dv95 is less than 450 nm. The symble ◯ refers to that Dv50 is ranged from 290 nm to 20 nm, and Dv95 is ranged from 450 nm to 500 nm. The symble Δ refers to that Dv50 is ranged from 320 nm to 360 nm, and Dv95 is greater than 500 nm. The symble X refers to that Dv50 is greater than 360 nm, and Dv95 is greater than 600 nm.

Measurement of whiteness

The obtained aqueous white color paste was formulated into a white ink composition containing 10 wt % of TiO₂, powders with a water soluble polyurethane dispersion (PUD). A black cloth treated with a pretreatment liquid was coated with the white ink composition by a scraper coating process with a coating machine (the wet film coating machine ZEHNTNER ZUA2000, and the electric coating machine ZERNTNER ZAA), wherein the coating rate was 5 mm/s, and the thickness of the coating film was set to be 150 μm. Next, the coating film on the black cloth was fixed by a hot pressing process with a hot press machine at 165° C. for 90 sec. The black cloth coated with the white ink composition after the fixing process was detected with Datacolor400, the illumination source used herein was filtered to approximate D65, and the CIE whiteness was measured. Alternatively, the black cloth coated with the white ink composition after the fixing process was detected by visual inspection.

Herein, the results of the visual inspection are defined from level 1 to level 5, wherein the level 1 means the whiteness is the worst, the whiteness is getting better when the level is increased, and the level 5 means the whiteness is the best.

The results of the measurements of the particle sizes and the whiteness are listed in the following Table 1.

TABLE 1

| | Comp. | Comp. | Comp. | Comp. | Comp. | Comp. | | | |
|---|---|---|---|---|---|---|---|---|---|
| | Ex 1 | Ex 2 | Ex 3 | Ex 4 | Ex 5 | Ex 6 | Ex 1 | Ex 2 | Ex 3 |
| TiO₂ | 50 wt % | | | | | 60 wt % | | | |
| (Primary | | | | | | | | | |
| particle size = | | | | | | | | | |
| X, Δ) | | | | | | | | | |
| BYK-190 | 12.5 wt % | — | — | | | — | | | |
| BYK-2010 | — | 12.5 wt % | — | | | — | | | |
| Joncryl ® HPD | — | | — | | | 11.5 wt % | | | |
| 196 | | | | | | | | | |
| Lutensol ® AT18 | — | | 36 wt % | | — | — | | | |
| solution | | | | | | | | | |
| Lutensol ® XP | — | | — | | 37 wt % | — | | | |
| 99 | | | | | | | | | |
| Triethylene | — | | 5 wt % | — | 5 wt % | — | | | |
| glycol | | | | | | | | | |
| monobutyl | | | | | | | | | |
| ether | | | | | | | | | |
| Diethylene | — | | — | 5 wt % | — | — | | | |
| glycol | | | | | | | | | |
| monobutyl | | | | | | | | | |
| ether | | | | | | | | | |
| Wetting agent | — | | — | | | 0 wt % | 1.5 wt % | 3 wt % | 5 wt % |
| TEGO | | | | | | | | | |
| Dispers652 | | | | | | | | | |
| Biocide | — | | — | | | 0.1 wt % | | | |
| IPA | 5 wt % | | — | | | — | | | |
| Water | Adding water to 100 wt % | | | | | | | | |
| Whiteness | 1 | 1 | 1 | 1 | 3 | 5 | 5 | 5 | 5 |
| (visual | | | | | | | | | |
| inspection) | | | | | | | | | |
| Whiteness | 68.21 | 69.22 | 71.32 | 70.12 | 76.10 | 88.01 | 89.52 | 87.35 | 88.12 |
| CIE value | | | | | | | | | |
| Particle sizes | Δ | Δ | Δ | Δ | Δ | Δ | ⊚ | ⊚ | ◯ |
| Dv50 and Dv95 | | | | | | | | | |

As shown in Table 1, the white ink compositions prepared by the aqueous white color paste of the comparative embodiments 1 to 6 show poor particle sizes and/or whiteness. On the other hand, the white ink compositions prepared by the aqueous white color paste of the embodiments 1 to 3 show excellent particle sizes and whiteness. Particularly, the aqueous white color paste of the comparative embodiment 6 contains anionic acrylic acid copolymer dispersant but does not contain the wetting agent, and the particle sizes of the TiO₂ powders are still large. However, the aqueous white color paste of the embodiments 1 to 3 contains the anionic acrylic acid copolymer dispersant and the wetting agent, the surface wettability of the TiO₂ powders can be increased in the aqueous system, the dispersion of the TiO₂ powders can be improved, and the particle sizes of the TiO₂ powders are in a desirable range. When the particle sizes of the TiO₂ powders are distributed to have small diameters, the TiO₂ powders contained in the ink does not block the nozzle for digital textile printing. In addition, compared with the comparative embodiments 1 to 5, when the non-ionic acrylic acid copolymer is used as the dispersant in the aqueous white color paste of the embodiments 1 to 3, the whiteness can be increased two or three levels by visual inspection,

The particle sizes of the TiO₂ powders in the aqueous white color paste of the embodiment 1 and in the commercial available white color pastes were measured. In addition, the whiteness of the white ink compositions prepared by the aqueous white color paste of the embodiment 1 and the commercial available white color pastes was also measured. The results are shown in the following Table 2.

TABLE 2

| | | Dainichiseika | | |
|---|---|---|---|---|
| | | Color & | | |
| | | Chemicals | | |
| | | Mfg. Co., Ltd. | Dimond | |
| White color | DIC FG White | JW-062 | PW066 | Ex 1 |
| paste | Japan | Japan | England | — |
| Particle sizes | Dv50 = 466 nm | Dv50 = 147 nm | Dv50 = 165 nm | Dv50 = 271 nm |
| Dv50 and Dv95 | Dv95 = 1202 nm | Dv95 = 323 nm | Dv95 = 332 nm | Dv95 = 410 nm |
| Whiteness | 3 | 3 | 2 | 5 |
| (visual | | | | |
| inspection) | | | | |

As shown in Table 2, the aqueous white color paste of the embodiment 1 shows better TiO₂ powder particle size distribution and excellent whiteness.

Hereinafter, the influence of different contents of the TiO₂ powders and different contents of the wetting agent on the TiO₂ powder particle size distribution in the aqueous white color paste is compared. In the following Table 3, only the differences between the embodiments 4 to 5 and the embodiments l to 2 are listed. The particle size of the TiO₂ powders, the species and the content of the dispersant, the species of the wetting agent, the species and the content of the biocide used in the embodiments 4 and 5 are the same as those used in the embodiments 1 and 2. The results are shown in the following Table 3.

TABLE 3

| | | | Particle size | |
|---|---|---|---|---|
| | | | before storage | |
| | TiO₂ powders | Wetting agent | (nm) | |
| | (wt %) | (wt %) | Dv50 | Dv95 |
| Comp. Ex 6 | 60 | 0 | 353 | 565 |
| Ex 1 | 60 | 1.5 | 271 | 410 |
| Ex 2 | 60 | 3 | 265 | 404 |
| Ex 4 | 65 | 3 | 287 | 454 |
| Ex 5 | 70 | 3 | 283 | 467 |

Hereinafter, the influence of different wetting agents on the TiO₂ powder particle size distribution in the aqueous white color paste is compared. In the following Table 4, only the differences between the embodiments 6 to 7 and the embodiment 2 are listed. The rest, such as the particle size of the TiO₂ powders and the species and the content of the biocide used in the embodiments 6 and 7 are the same as those used in the embodiment 2.

TABLE 4

| | | | Wetting agent (wt %) | | | | |
|---|---|---|---|---|---|---|---|
| | | Dispersant | TEGO ® | EDAPLAN ® | METOLAT | | |
| | TiO₂ | Joncryl ® | Dispers652 | 915 | 390 | Particle size | |
| | powders | HPD 196 | Molecule | Molecule | Molecule | (nm) | |
| | (wt %) | (wt %) | weight: 1600 | weight: 910 | weight: 1950 | Dv50 | Dv95 |
| Ex 2 | 60 | 11.5 | 3 | — | — | 265 | 404 |
| Ex 6 | 60 | 11.5 | — | 3 | — | 266 | 402 |
| Ex 7 | 60 | 11.5 | — | — | 3 | 296 | 424 |

According to the results shown in Table 4, when different fatty acid derivatives are used as the wetting agents, all the obtained aqueous white color pastes have good stability, dispersion and particle size distribution.

Hereinafter, the influence of different dispersants on the TiO₂ powder particle size distribution in the aqueous white color paste is compared. In the following Table 5, only the differences between the embodiment 1 and the comparative embodiments 7 to 8 and between the embodiment 1 and the embodiments 8 to 9 are listed. The rest, such as the particle size of the TiO₂ powders and the species and the content of the biocide used in the comparative embodiments 7 to 8 and the embodiments 8 to 9 are the same as those used in the embodiment 1. The results are shown in the following Table 5.

TABLE 5

| | TiO₂ | Dispersant | Dispersant | Wetting agent | Particle size | |
|---|---|---|---|---|---|---|
| | powders | Joncryl ® 586 | DISPERBYK-2015 | TEGO ®Dispers652 | (nm) | |
| | (wt %) | (wt %) | (wt %) | (wt %) | Dv50 | Dv95 |
| Comp. | 60 | 11.5 | — | 0 | 354 | 592 |
| Ex 7 | | | | | | |
| Ex 8 | 60 | 11.5 | — | 3 | 288 | 462 |
| Comp. | 60 | — | 11.5 | 0 | 332 | 552 |
| Ex 8 | | | | | | |
| Ex9 | 60 | — | 11.5 | 3 | 280 | 425 |

According to the results shown in Table 5, when different acrylic acid copolymer are used as the dispersants, all the obtained aqueous white color pastes have good stability, dispersion and particle size distribution. In addition, compared with the comparative embodiments 7 and 8, the aqueous white color pastes of the embodiments 8 and 9 have good dispersion and particle size distribution when the acrylic acid copolymer as the dispersant and the fatty acid derivatives as the wetting agents are used together.

According to the results shown in Table 1 to Table 4, when the random acrylic acid copolymer is used as the dispersant and the fatty acid derivative is used as the wetting agent in the aqueous white color paste of the present disclosure, the wetting agent in the aqueous white color paste can improve the surface wettability of the TiO₂ powders to improve the dispersion of the TiO₂ powders in the aqueous white color paste. Thus, the particle size of the aqueous white color paste can be significantly reduced. In addition, the obtained aqueous white color paste can show excellent stability and whiteness. Furthermore, the aqueous white color paste of the present disclosure has excellent storage stability and stably dispersion, and thus no flocculation or coagulation is generated in the aqueous white color paste of the present disclosure.

The aqueous white color paste prepared in the embodiment 1 was formulated into a white ink composition according to the formulation shown in the following Table 6. A black cloth treated with a pretreatment liquid was coated with the obtained white ink composition by an inkjet printing process with a printing machine (Epson 4880), and good inkjet printability can be obtained.

TABLE 6

| White ink composition | Content (wt %) |
|---|---|
| Aqueous white color paste of | 15-20 |
| the embodiment 1 | |
| Ethylene Glycol | 10-20 |
| Glycerol | 5-10 |
| Dispersant BYK-349 | 0.1-0.5 |
| Biocide | 0.1-0.2 |
| PUD(1010NHR) | 20-35 |
| Cross-linking agent | 1-3 |
| water | Adding to 100% |

After the tests on the washing fastness (AATCC 61 3A) and the dry/wet rubbing fastness (AATCC 8), the white pattern obtained by the inkjet printing process has the washing fastness at levels 4 to 5 and the dry/wet rubbing fastness at levels 4 to 5.

Although the present invention has been explained in relation to its preferred embodiment, it is to be understood that many other possible modifications and variations can be made without departing from the spirit and scope of the invention as hereinafter claimed.

What is claimed is:

1. An ultra-high whiteness aqueous white color paste for digital textile printing ink, comprising:
40 wt % to 70 wt % of TiO₂ powders;
1 wt % to 5 wt % of a wetting agent;
2 wt % to 12 wt % of a dispersant; and
rest of water,
wherein the TiO₂ powders are rutile TiO₂ powders, the wetting agent is a fatty acid derivative, and the dispersant is an acrylic acid copolymer.

2. The ultra-high whiteness aqueous white color paste of claim 1, wherein the dispersant is an anionic dispersant, a non-ionic dispersant or a combination thereof.

3. The ultra-high whiteness aqueous white color paste of claim 2, wherein the dispersant is the anionic dispersant.

4. The ultra-high whiteness aqueous white color paste of claim 1, wherein a molecular weight of the fatty acid derivative is ranged from 500 to 2000.

5. The ultra-high whiteness aqueous white color paste of claim 1, wherein the acrylic acid copolymer is a random acrylic acid copolymer.

6. The ultra-high whiteness aqueous white color paste of claim 1, wherein Dv50 of the TiO₂ powders is ranged from 200 nm to 320 nm, and Dv95 of the TiO₂ powders is less than 500 nm.

7. The ultra-high whiteness aqueous white color paste of claim 1, wherein a content of the wetting agent is ranged from 1.5 wt % to 3 wt %.

8. The ultra-high whiteness aqueous white color paste of claim 1, wherein a CIE whiteness of the ultra-high whiteness aqueous white color paste is greater than 85.

9. The ultra-high whiteness aqueous white color paste of claim 1, wherein the ultra-high whiteness aqueous white color paste is prepared by pulverizing a mixture containing primary TiO₂ powders, the wetting agent, the dispersant and the water through a milling process, wherein the milling process is a media milling process, a basket milling process, a high speed dispersion process, or a combination thereof.

10. An ink composition for digital textile printing, comprising:
15 wt % to 20 wt % of an ultra-high whiteness aqueous white color paste, wherein the ultra-high whiteness aqueous white color paste comprises:
40 wt % to 70 wt % of TiO₂ powders based on a total weight of the ultra-high whiteness aqueous white color paste;
1 wt % to 5 wt % of a wetting agent based on the total weight of the ultra-high whiteness aqueous white color paste;
2 wt % to 12 wt % of a dispersant based on the total weight of the ultra-high whiteness aqueous white color paste; and
rest of water based on the total weight of the ultra-high whiteness aqueous white color paste,
wherein the TiO₂ powders are rutile TiO₂ powders, the wetting agent is a fatty acid derivative, and the dispersant is an acrylic acid copolymer;
20 wt % to 35 wt % of a resin;
1 wt % to 3 wt % of a cross-linking agent;
0.1 wt % to 0.5 wt % of a surfactant;
15 wt % to 30 wt % of a water soluble organic solvent,
0.1 wt % to 0.2 wt % of a biocide; and
rest of water.

11. The ink composition of claim 10, wherein the dispersant is an anionic dispersant, a non-ionic dispersant or a combination thereof.

12. The ink composition of claim 11, wherein the dispersant is the anionic dispersant.

13. The ink composition of claim 10, wherein a molecular weight of the fatly acid derivative is ranged from 500 to 2000.

14. The ink composition of claim 10, wherein the acrylic acid copolymer is a random acrylic acid copolymer.

15. The ink composition of claim 10, wherein Dv50 of the TiO₂ powders is ranged from 200 nm to 320 nm, and Dv95 of the TiO₂ powders is less than 500 nm.

16. The ink composition of claim 10, wherein a content of the wetting agent is ranged from 1.5 wt % to 3 wt %.

17. The ink composition of claim 10, wherein a CIE whiteness of the ultra-high whiteness aqueous white color paste is greater than 85.

18. The ink composition of claim 10, wherein the ultra-high whiteness aqueous white color paste is prepared by pulverizing a mixture containing primary TiO₂ powders, the wetting agent, the dispersant and the water through a milling process, wherein the milling process is a media milling process, a basket milling process, a high speed dispersion process, or a combination thereof.
